(19) United States
(12) Patent Application Publication
(10) Pub. No.: US 2008/0197975 A1
(43) Pub. Date: Aug. 21, 2008

(54) Radio Frequency Identification Data Processing System

(76) Inventors: Seung Hyup Ryoo, Seoul (KR); Jin Tae Kim, Seoul (KR); Sang Cheol Min, Seoul (KR); Hee Seung Kim, Seoul (KR); Jae Joon Park, Seoul (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/914,938

(22) PCT Filed: May 19, 2006
(86) PCT No.: PCT/KR2006/001899

§ 371 Date: Nov. 19, 2007

Related U.S. Application Data
(60) Provisional application No. 60/683,252, filed on May 20, 2005.

(51) Int. Cl. H04Q 7/24; H04Q 7/20

(52) U.S. Cl. 340/10.1

(57) ABSTRACT

Provided is a system for processing an RFID tag data. Also, provided are an application layer framework of a mobile terminal to which an RFID technology is applied, and a system for processing an RFID data based on the application layer framework. The system processes RFID data such that a mobile terminal reads and processes various kinds of RFID tags when various kinds of RFID tags are received.

### TECHNICAL FIELD

The present invention relates to a system of recognizing and processing radio frequency identification (RFID) data.

### BACKGROUND ART

International Standards Organization (ISO) and Electronic Product Code (EPC) standards define a reader protocol that supports connection of an RFID reader to a host through a network. In RFID systems, an RFID reader is mounted on a terminal or attached to the terminal in a dongle configuration. An RFID reader control unit of the terminal controls the RFID reader to write/read data to/from a tag.

In terminal environments, an RFID system is employed between a processor (e.g., MPU and MCU) of a terminal and an RFID reader chip installed in the terminal. Alternatively, a reader protocol is employed between a terminal and an RFID reader attached onto the terminal in a dongle configuration. When an RFID reader is attached onto a terminal in a dongle configuration, the RFID reader and the terminal are connected by an interface unit such as Universal Asynchronous Receiver/Transmitter (UART) or Universal Serial Bus (USB).

### DISCLOSURE OF INVENTION

### Technical Problem

An object of the present invention is to provide an RFID tag data processing method and an RFID data processing system.

Another object of the present invention is to provide an application layer framework of a terminal to which an RFID technology is applied, and a RFID data processing system based on the application layer framework.

Still another object of the present invention is to provide a system for processing an RFID data that allows a terminal to read and process various kinds of tags when various kinds of RFID tags are used.

### Technical Solution

According to one aspect of the present invention, there is provided a mobile terminal including: an RFID reader for recognizing an RFID tag data; a middleware for processing data between the RFID reader and an application within the mobile terminal; a user interface handler for interfacing between a user and a mobile terminal; a command handler for processing a command to control the RFID reader; and a tag data handler for processing tag data recognized by the RFID reader.

According to another aspect of the present invention, there is provided a mobile terminal including: an RFID reader for recognizing RFID tag data of a multi-code type; a multi-tag decoder for converting a structure of the RFID tag data of the multi-code type recognized by the RFID reader; and a middleware for processing data between the multi-tag decoder and an application inside a mobile terminal.

According to a further another aspect of the present invention, there is provided a method of controlling execution of an RFID application of a mobile terminal, the method including: recognizing a user's command regarding RFID data processing; controlling an RFID reader through a middleware according to the user's command; determining actuation required for tag data recognized by the RFID reader; and executing a corresponding application according to the determined actuation.

### Advantageous Effects

According to the present invention, an RFID system provides an application layer framework to apply an RFID reader to a mobile terminal, thereby providing a basis on which a variety of applications realized through a tag data processing technology are provided.

The present invention is applied to an RFID system, and more abundant and various applications can be realized using data read from a tag, and a mobile terminal RFID system can process various kinds of tag formats using a multi-tag decoding technique.

### BRIEF DESCRIPTION OF THE DRAWINGS

FIGS. 1 and 2 are views illustrating construction of a mobile RFID apparatus according to an embodiment of the present invention;

FIG. 3 is a view illustrating a structure of a reader and an RFID data processing module of a mobile terminal according to an embodiment of the present invention;

FIG. 4 is a view illustrating a structure of an application framework of a mobile terminal according to an embodiment of the present invention;

FIG. 5 is a view illustrating a setting process according to an embodiment of the present invention;

FIG. 6 is a view illustrating a process of registering a tag according to an embodiment of the present invention;

FIG. 7 is a view illustrating a process of manually reading a tag according to an embodiment of the present invention;

FIG. 8 is a view illustrating a process of automatically reading a tag according to an embodiment of the present invention;

FIG. 9 is a view illustrating structures of a tag, a reader, and a multi-tag decoder of a mobile terminal according to an embodiment of the present invention; and

FIG. 10 is a view illustrating a process of recognizing a multi-tag according to an embodiment of the present invention.

### BEST MODE FOR CARRYING OUT THE INVENTION

Hereinafter, preferred embodiments of the present invention will be described in detail with reference to accompanying drawings. The preferred embodiments should be considered in descriptive sense only and not for purposes of limitation.

An RFID data processing system according to the present invention includes: an RFID reader for reading data written into a tag; and a tag data processor for recognizing and processing the data read by the RFID reader. The tag data processor may be, for example, a mobile terminal. The mobile terminal may be, for example, a mobile phone. The RFID reader may be installed in the mobile terminal. Alternatively, the RFID reader may be connected through an interface unit to the mobile terminal in a dongle configuration.

In the following embodiments of the present invention, a mobile terminal (e.g., a mobile phone) with an RFID reader is taken as an example of a terminal with an RFID reader control unit.

The present invention provides a framework of an application layer required when an RFID technology is applied to a mobile terminal. There are various application programs that can be realized using technology for applying an RFID reader to a mobile terminal to read tag data. The present invention provides a framework for realizing these applications.

An RFID uses tags and a reader for the basis, and performs an appropriate operation by allowing the reader to read information contained in the tag. The tag can be classified into a passive tag and an active tag. Since the passive tag operates without power of its own, the passive tag has a short operation distance. On the other hand, since the active tag operates with power of its own, the active tag has a long operation distance. The present invention provides a framework structure of an application software that will be realized to a mobile terminal and a method of processing RFID data when the RFID technology is applied to the mobile terminal to realize an RFID mobile terminal.

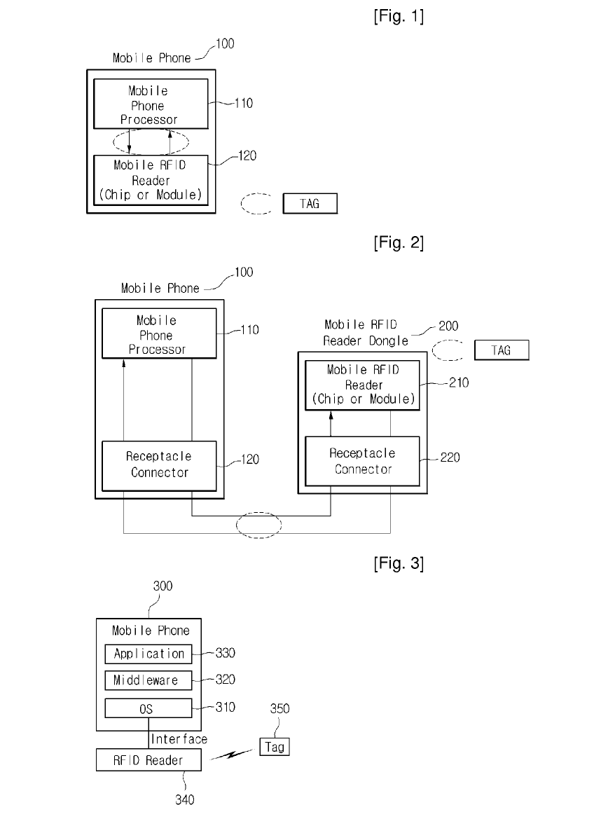

FIG. 1 is a view illustrating construction of a mobile RFID system when a mobile RFID reader is included inside a mobile terminal (here, a mobile phone). FIG. 2 is a view illustrating construction of a mobile RFID system when a mobile RFID reader is mounted on an outside of a mobile terminal (here, a mobile phone) in a dongle configuration.

Referring to FIG. 1, a mobile phone 100 includes a mobile phone processor 110 and a chip-type or module-type mobile RFID reader 120. The mobile phone processor 110 controls the mobile RFID reader 120. Under the control of the mobile phone processor 110, the mobile RFID reader 120 writes/reads data to/from a tag. The tag data read by the mobile RFID reader 120 are transferred to the mobile phone processor 110. The mobile phone processor 110 decodes and recognizes the tag data. The mobile phone processor 110 stores the recognized tag data or provides the recognized tag data to a user using a display device.

Referring to FIG. 2, a mobile phone 100 includes a mobile phone processor 110 and a receptacle connector 120. A mobile RFID reader 210 is attached to an outside of the mobile phone 100 in a dongle configuration. The mobile RFID reader 210 is connected to the mobile phone 100 by receptacle connectors 120 and 220. The mobile phone processor 110 controls the mobile RFID reader 210 through the receptacle connectors 120 and 220. Under the control of the mobile phone processor 110, the mobile RFID reader 210 writes/reads data to/from a tag. The tag data read by the mobile RFID reader 210 are transferred to the mobile phone processor 110 through the receptacle connectors 120 and 220. The mobile phone processor 110 decodes and recognizes the tag data. The mobile phone processor 110 stores the recognized tag data or provides the recognized tag data to a user using a display device.

FIG. 3 is a view illustrating a structure of a reader and an RFID data processing module of a mobile terminal according to an embodiment of the present invention. A mobile terminal 300 according to the present invention includes an operation system (OS) 310, a middleware 320, and an application 330. An RFID reader 340 is connected to a mobile terminal through an interface such as UART. The RFID reader 340 reads information contained in a tag 350 and delivers the read information to the mobile terminal 300 through the interface. In the mobile terminal 300, the tag information passes through the OS 310, is delivered to the middleware 320, and delivered to the application layer 330. The middleware 320 of the mobile terminal 300 may be a WIFI, which is a radio Internet software platform. The present invention provides a framework of an application layer that uses RFID-related service provided by the middleware 320.

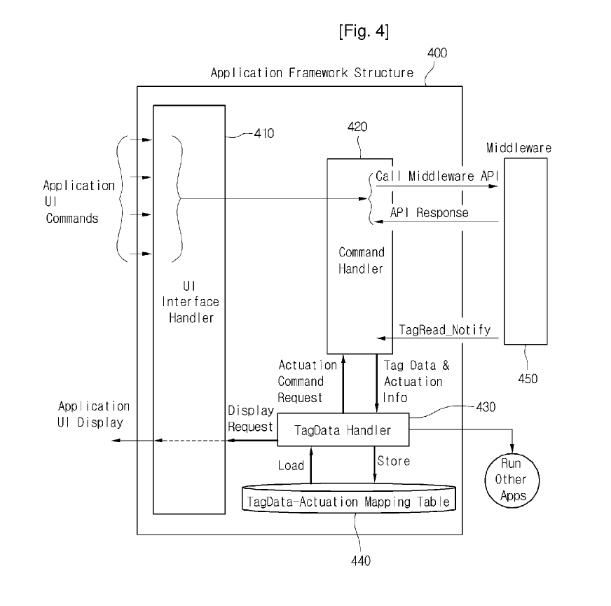

FIG. 4 is a view illustrating a structure of an application framework of a mobile terminal according to an embodiment of the present invention. The application framework 400 according to the present invention includes an UI interface handler 410, a command handler 420, a tag data handler 430, and a tag data actuation mapping table 440.

The UI interface handler 410 delivers a command and data between a user interface (UI), the command handler 420, and the tag data handler 430. The UI includes a key interface and a display device of the mobile terminal. When an application UI command is given, the UI interface handler 410 receives this command and delivers this command to the command handler 420, and displays corresponding data through an application UI display when a data display request is made by the tag data handler 430.

The command handler 420 calls an Application Programming Interface (API) of the middleware 450, and receives and processes a response thereof (API response). Also, the command handler 420 receives a TagRead_Notify from the middleware 450 and processes the same. The command handler 420 delivers tag data & actuation info. to the tag data handler 430, and receives actuation command request from the tag data handler 430 and processes the same.

The tag data handler 430 determines actuation to be taken according to tag data and tag data & actuation Info. delivered from the command handler 420. At this point, the tag data handler 430 determines actuation to be performed with reference to actuation info (information). delivered from the command handler 420. The tag data handler 430 determines actuation with reference to actuation information delivered from the command handler 420 and the tag data actuation mapping table 440. Necessary information is stored in the tag data actuation mapping table 440 by the tag data handler 430, or necessary information is loaded from the tag data actuation mapping table 440 to the tag data handler 430.

A tag data process performed according to an application framework structure illustrated in FIG. 4 will be described in detail. When a command is given from an application UI, the UI interface handler 410 receives this command and delivers this command to the command handler 400.

The command handler 420 converts a command from the application UI and calls an API provided from the middleware 450. The middleware 420 performs a response in response to an API call from the command handler 420 (API response), and delivers data read from a tag to the command handler 420. That is, as described with reference to FIGS. 1 to 3, the RFID reader reads data of the tag, and tag data read by the RFID reader is delivered to the application layer via the middleware.

When data of a tag read by the middleware 450 is received, the command handler 420 delivers the tag data to the tag data handler 430. At this point, the command handler 420 delivers actuation information together with tag data. The tag data handler 430 determines actuation to be taken with reference to actuation information delivered from the command handler 420. That is, the tag data handler 430 determines actuation to be taken with reference to actuation information delivered from the command handler 420 and the tag data actuation mapping table 440.

The above-described RFID application may be a scenario of reading tag data to access a network and accessing to an Internet site mapped to the tag data to download corresponding information. In this case, information coming from the middleware is simply an address of an Internet site. Therefore, the actuation mapping table is referred according to tag data coming from the middleware so that a corresponding Internet site address is accessed, and necessary information is downloaded from a corresponding server. For example, it is possible to fetch contents desired by a user from a mobile communication company's server through wireless application protocol (WAP) browser using a contents server address. With an RFID application according to the present invention, it is possible to use applications such as shortcut using a tag, memo, and schedule management, as well as access to an Internet site as described above. Here, since the application can be realized in various ways by a person skilled in the art, detailed descriptions will be omitted.

Actuation determined by the tag data handler 430 with reference to the tag data and the actuation information allows tag data or a corresponding application to be displayed. This is performed when the tag data handler 430 makes a display request to the UI interface handler 410, and the UI interface handler 410 operates an application UI display in response to this display request. Besides, various other applications are executed (run other apps.).

An embodiment of an RFID application scenario according to the present invention will be described below. The RFID application scenario according to an embodiment of the present invention includes configuration, and tag registration, tag reading. The configuration determines a variety of option parameters. The tag registration maps a predetermined tag to a desired actuation. The tag reading reads tag data. The tag reading includes manual reading and auto reading. The manual reading and the auto reading are determined depending on option configuration. When auto reading is set by the option configuration, the reader continuously transmits electromagnetic waves to find out a tag when power of the reader is on. When auto reading is disabled, a tag is read only when a user directly gives a reading command through the UI. The manual reading function allows a user to save power.

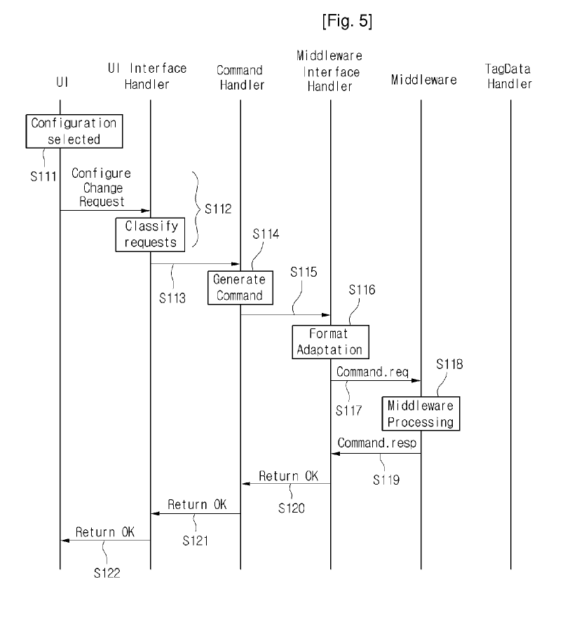

FIG. 5 is a flowchart illustrating a setting process according to an embodiment of the present invention. Configuration directly delivers an option selected by a user through the UI to the middleware to set corresponding parameters. The setting process will be described with reference to FIG. 5.

A first step S111 is a step of selecting a setting command at an UI. The second step S112 is a step of delivering a request according to a setting command selected by the UI to a handler, and processing, at an UI interface handler, the request. A third step S113 is a step of delivering a setting command to a command handler from the UI interface handler. A fourth step S114 is a step of generating, at the command handler, a command that is to be delivered to a middleware. A fifth step S115 is a step of delivering the generated command to a middleware interface handler. Here, the middleware intervenes between the command handler and the middleware in a structure illustrated in FIG. 4, and is responsible for information delivery and processing between the middleware and the command handler. A sixth step S116 is a step of adapting, at the middleware handler, a command format to a format suitable for the middleware. That is, the command delivered from the command handler to the middleware is delivered to the middleware in a manner of calling an API provided by the middleware. A seventh step S117 is a step of delivering a corresponding command to the middleware. An eight step S118 is a step of performing, at the middleware, setting of various option parameters that correspond to the setting command. The middleware sets and changes option parameters with reference to information contained in the API. After that, a response is delivered in a reverse order (S119-S122). A ninth step S119 is a step of delivering results obtained by performing the setting command to the middleware handler as a response. A tenth step S120 to a twelveth step S122 describe a process of delivering corresponding results to the UI from the middleware handler through the command handler and the UI interface handler.

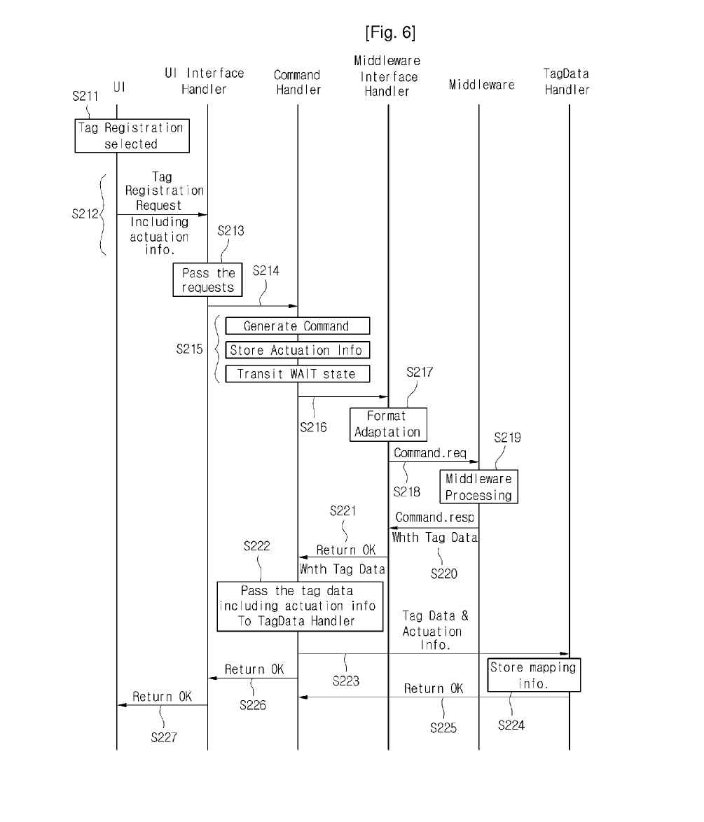

FIG. 6 is a flowchart illustrating a process of registering a tag according to an embodiment of the present invention. Tag registration maps a predetermined tag to desired actuation. A predetermined tag is mapped to actuation determined by a user such that an operation desired by a user can be automatically performed when a tag is read. This mapping information is stored in a tag data actuation mapping table.

The UI allows a user to select a tag registration menu and select an actuation in which a tag is to be registered. Such a tag registration request and actuation information are delivered to the command handler through the UI interface handler. The command handler generates a corresponding command and stores the actuation information. A tag registration request command from the command handler is delivered to the middleware in a manner of calling an API of the middleware. The middleware performs a tag reading command and delivers information contained in the read tag to the command handler. Accordingly, the command handler delivers stored actuation information and tag data to the tag data handler. The tag data handler receives the tag data from the middleware and judges an appropriate actuation to perform a corresponding actuation.

A tag registration process will be described in detail with reference to FIG. 6. A first step S211 is a step of allowing a user to select a tag registration menu through an UI, and to select an actuation in which a tag is to be registered. A second step S212 is a step of delivering a tag registration request command and actuation information selected through the UI to an UI interface handler. A third step S213 and a fourth step S214 are processes for delivering the tag registration request command and the actuation information to the command handler. A fifth step S215 is a step of generating, at the command handler, a corresponding command, storing actuation information, and transferring to a WAIT state. A sixth step S216 is a step of delivering, at a command handler, the tag registration request command to a middleware interface handler. A seventh step S217 is a step of adopting, at the middleware handler, a command format to a format suitable for the middleware. That is, the command delivered from the command handler to the middleware is delivered to the middleware in a manner of calling an API provided by the middleware. An eight step S218 is a step of delivering a corresponding command to the middleware. A ninth step S219 is a step of performing, at the middleware, a tag information reading command according to the command. A tenth step S220 and an eleventh step S221 are processes of providing tag information read by the middleware to the command handler as a response through the middleware interface handler. A twelveth step S222 and a thirteenth step S223 are steps in which the command handler gets out of a WAIT state and delivers actuation information stored in advance and tag data to the tag data handler. A fourteenth step S224 is a step of receiving, at the tag data handler, tag data from the middleware and performing a corresponding actuation. A fifteenth step S225 to a seventeenth step S227 describe processes of delivering results obtained by performing the command over a range from the UI to the tag data handler as a response.

Actuation judged by the tag data handler in the fourteenth step S224 includes four examples blow.

1. Tag Data Actuation Mapping Table Store/Load. In this actuation, actuation information mapped through a tag registration process is stored, or when a tag is read and data is received, actuation information suitable for the tag is loaded from a table. Here, a storing process occurs only during tag registration, and when a tag is read, corresponding mapping information is loaded and brought.

2. Actuation Command Request. An actuation according to mapping information stored in a tag data actuation mapping table transmits this message to the command handler when requesting a command request regarding the middleware to generate a command request directed to the middleware.

3. Display Request. This actuation is an operation of directly sending data to an UI when an RFID application UI immediately displays information generated by tag data.

4. Run Other Application. This actuation is an operation of executing a relevant application program when the actuation is an actuation such as an Internet browser, a scheduling program, and audio file reproduction.

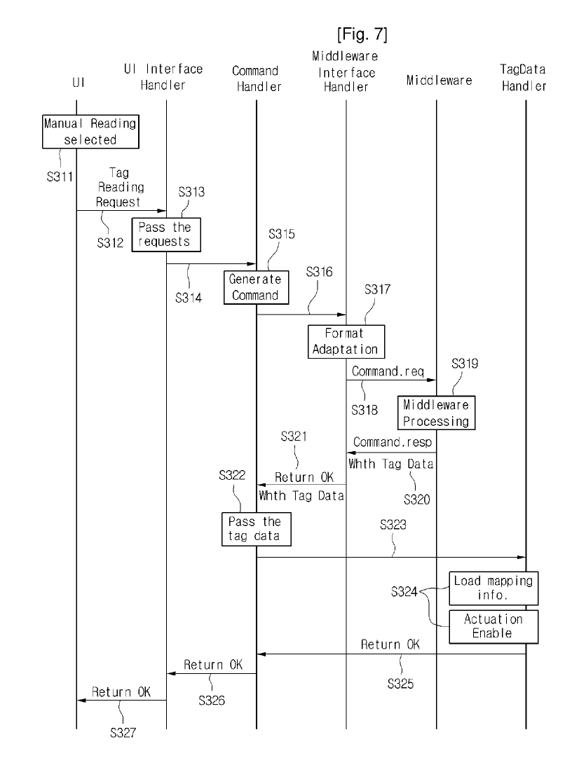

FIG. 7 is a flowchart illustrating a process of manually reading a tag according to an embodiment of the present invention. During the manual tag reading, a manual tag reading command is delivered to the middleware from the UI. When the tag data read by the middleware is delivered to the command handler, the command handler delivers this tag data to the tag data handler. The tag data hander loads mapping information from the tag data actuation mapping table to deliver a message such that mapped actuation is performed.

The process of manually reading the tag will be described in detail with reference to FIG. 7. A first step S311 is a step of allowing a user to select a manual tag reading menu through the UI. A second step S312 is a step where a manual tag reading request selected through the UI is delivered to an UI interface handler. A third step S313 and a fourth step S314 are steps where the manual tag reading request is delivered to the command handler. A fifth step S315 is a step of generating a corresponding command at the command handler. A sixth step S316 is a step of delivering, at the command handler, the manual tag reading command to the middleware interface handler. A seventh step S317 is a step of adapting, at a middleware interface handler, a command format to a format suitable for the middleware. That is, the command delivered from the command handler to the middleware is delivered to the middleware in a manner of calling an API provided by the middleware. An eighth step S318 is a step of delivering a corresponding command to the middleware. A ninth step S319 is a step of performing, at the middleware, a tag information reading command according to the above command. A tenth step S320 and an eleventh step S321 are processes of providing tag information read by the middleware to the command handler as a response through the middleware interface handler. A twelveth step S322 and a thirteenth step S323 are steps of delivering, at the command handler, tag data to the tag data handler. A fourteenth step S324 is a step of loading, at the tag data handler, mapping information from the tag data actuation mapping table and delivering a message such that a mapped actuation is performed. A fifteenth step S325 to a seventeenth step S327 describe processes of delivering results obtained by performing the command over a range from the UI to the tag data handler as a response.

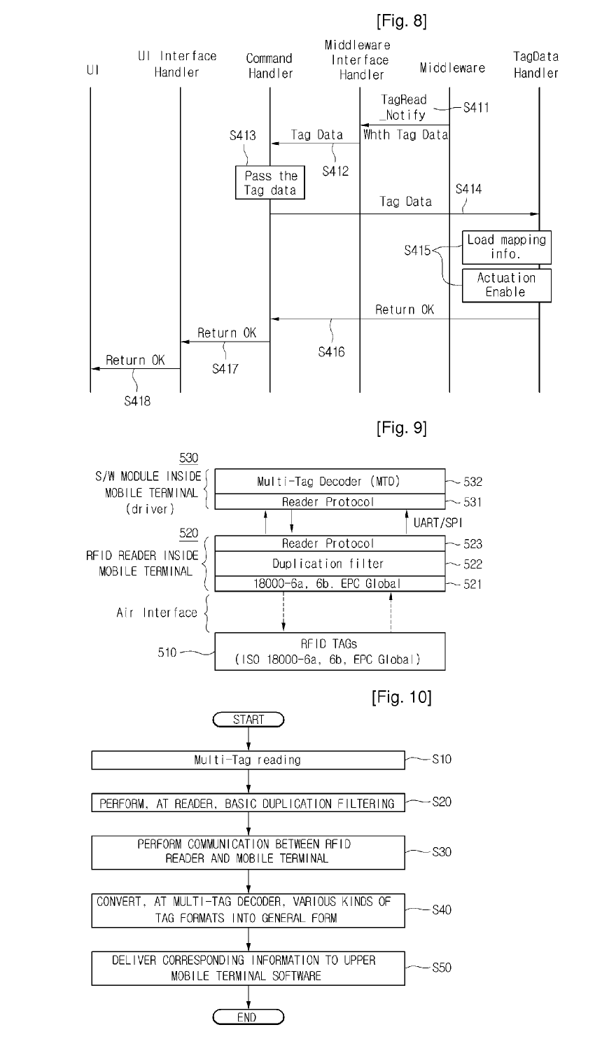

FIG. 8 is a flowchart illustrating a process of automatically reading a tag according to an embodiment of the present invention. During an automatic tag reading operation, automatically read tag data comes onto the command handler, which delivers the tag data to the tag data handler. The tag data handler loads mapping information from the tag data actuation mapping table to determine an actuation to be mapped.

The process of automatically reading the tag will be described in detail with reference to FIG. 8. A first step S411 is a step of performing, at the middleware, a tag information reading command according to automatic tag reading setting to deliver tag data and a TagRead_Notify to a middleware interface handler. A second step S412 is a step of delivering the tag data from the middleware interface handler to a command handler. A third step S413 and a fourth step S414 are steps of delivering, at the command handler, the tag data to the tag data handler. A fifth sep S415 is a step of loading, at the tag data handler, mapping information from the tag data actuation mapping table and delivering a message such that a mapped actuation is performed. A sixth step S416 to an eighth step S418 describe processes of delivering results obtained by performing the command over a range from the UI to the tag data handler as a response.

When RFID tag data processing is performed according to the above-described RFID application framework, various kinds of tag data may be provided. A related art RFID system is generally used for circulation and distribution environments, and each region of a circulation and distribution system generally uses one standard protocol. For example, an EPC code or an ISO code is used. However, when various kinds of RFID tags are present, an RFID mobile terminal system should receive and process these RFID tags.

The present invention provides an element for providing tag information of a general format to a middleware within a mobile terminal when various kinds of RFID readers are provided to a mobile terminal such that the mobile terminal can read various kinds of tags under various kinds of RFID tag environments. This is realized using multi-tag decoding. When a multi-tag decoder converts each field of various kinds of tags into a general form and delivers the general form to an upper middleware layer, the middleware receives tag information of the general form, so that necessary process such as filtering can be performed.

FIG. 9 is a view illustrating structures of a tag, a reader, and a multi-tag decoder of a mobile terminal according to an embodiment of the present invention. An RFID tag 510 has a tag format according to various standards such as ISO 18000-6a, 6b, and EPC Global. An RFID reader 520 reads RFID tag data through air interface. For this purpose, the RFID reader 520 includes an interface 521, a duplication filter 522, and a reader protocol 523. The RFID reader 520 is connected to a multi-tag decoding module 530 on the basis of UART or SPI. The multi-tag decoding module 530 includes a reader protocol 531 and a multi-tag decoder 532. The multi-tag decoding module 530 is connected to a middleware.

When a tag 510 that conforms to various kinds of standards is recognized by the RFID reader 520 as illustrated in FIG. 9, the RFID reader performs a duplication filtering process of, when one tag is read several times, processing such that only one time of reading is recognized. The tag data filtered in this manner is delivered to the multi-tag decoding module 530 of the mobile terminal. For this purpose, the RFID reader 520 has an interface 521 with a tag to read data from a tag 510. Also, a duplication filtering process of tag data is performed through the duplication filter 522, and tag data is delivered to a multi-tag decoder 532 via an interface protocol (reader protocol) 523, 531 between the RFID reader 520 and the multi-tag decoding module 530. The multi-tag decoder 532 converts a multi-code type RFID tag into a tag of a general type structure, and the converted data is delivered to the above-described middleware, so that processing of corresponding data is performed on the basis of a proposed application framework structure.

The multi-tag decoder 532 converts each field of a tag provided from the RFID reader 520 into a general type and provides the same to the middleware. For example, each field of tag data conforming to EPC Global or each field of tag data conforming to ISO 18000-6a and 6b is converted into a structured tag data format and provided to the middleware. That is, the multi-tag decoder converts each field of various kinds of tags into a general form, i.e., a form of Field_1-Field_2-Field_n, and allows arbitrary each field Field_x to properly correspond to each field of a tag conforming to EPC Global or ISO 18000-6a and 6b, so that the middleware can process data of a consistent format regardless of the kinds of a tag.

FIG. 10 is a flowchart illustrating a process of recognizing a multi-tag according to an embodiment of the present invention.

A first step S10 is a step of reading, at an RFID reader 520, various kinds of tags 510. A second step S20 is a step of performing, at the RFID reader 520, a basic duplication filtering function. A third step S30 is a process of performing communication between the RFID reader 520 and a mobile terminal on the basis of a reader protocol to deliver tag data to a multi-tag decoding module 530. A fourth step S40 is a step of converting, at the multi-tag decoding module 530, various kinds of tag formats into a general format. A fifth step S50 is a step of delivering, at the multi-tag decoding module 530, the converted tag data to an upper mobile terminal software (i.e., a middleware).

The above-described embodiments are provided for purposes of understanding and convenience in explanation, and thus it will be apparent to those skilled in the art that various modifications and variations can be made therein without departing from the spirit and scope of the invention.

### INDUSTRIAL APPLICABILITY

According to the present invention, an RFID system provides an application layer framework, so that a basis on which a variety of applications realized through a tag data processing technology are provided.

The present invention is applied to an RFID system, and more abundant and various applications can be realized using data read from a tag, and a mobile terminal RFID system can process various kinds of tag formats using a multi-tag decoding technique.

1. A mobile terminal comprising:
an RFID (radio frequency identification) reader for recognizing RFID tag data;
a middleware for processing data between the RFID reader and an application within the mobile terminal;
a user interface handler for interfacing between a user and a terminal;
a command handler for processing a command to control the RFID reader; and
a tag data handler for processing the RFID tag data recognized by the RFID reader.

2. The mobile terminal according to claim 1, wherein the command handler calls an API (Application Programming Interface) provided by the middleware to execute a corresponding command.

3. The mobile terminal according to claim 1, wherein the tag data handler determines an actuation for corresponding tag data according to actuation information provided by the command handler.

4. The mobile terminal according to claim 1, further comprising a tag data actuation mapping table for providing information determining, at the tag data handler, actuation for tag data.

5. A method of controlling execution of an RFID application of a mobile terminal, the method comprising:
recognizing a user's command regarding RFID data processing;
controlling an RFID reader according to the user's command through a middleware;
determining actuation required for tag data recognized by the RFID reader; and
executing a corresponding application according to the determined actuation.

6. The method according to claim 5, wherein the user's command regarding the RFID data processing and an application thereof is one of configuration, tag registration, and tag reading.

7. The method according to claim 5, wherein the user's command regarding the RFID data processing and an application thereof determine option parameters regarding tag data processing.

8. The method according to claim 5, wherein the user's command regarding the RFID data processing and an application thereof map a predetermined tag to a desired actuation.

9. The method according to claim 5, wherein the user's command regarding the RFID data processing and an application thereof automatically read data of a tag.

10. The method according to claim 5, wherein the user's command regarding the RFID data processing and an application thereof manually read data of a tag.

11. The method according to claim 5, wherein the user's command regarding the RFID data processing and an application thereof map a predetermined tag to a desired actuation, which stores mapped actuation information.

12. The method according to claim 5, wherein the user's command regarding the RFID data processing and an application thereof map a predetermined tag to a desired actuation, which loads actuation information suitable for a tag from mapped actuation information.

13. The method according to claim 5, wherein the user's command regarding the RFID data processing and an application thereof map a predetermined tag to a desired actuation, which is an actuation command request directed to the middleware.

14. The method according to claim 5, wherein the user's command regarding the RFID data processing and an application thereof map a predetermined tag to a desired actuation, which is a display request.

15. The method according to claim 5, wherein the user's command regarding the RFID data processing and an application thereof map a predetermined tag to a desired actuation, which is an operation that executes a corresponding application.

16. The method according to claim 5, wherein the user's command regarding the RFID data processing and an application thereof map a predetermined tag to a desired actuation, which is an operation of executing an Internet browser, a scheduling program, and an audio file reproduction program mounted in the mobile terminal.

17. A mobile terminal comprising:
an RFID reader for recognizing RFID tag data of a multi-code type;
a multi-tag decoder for converting a structure of the RFID tag data of the multi-code type recognized by the RFID reader; and
a middleware for processing data between the multi-tag decoder and an application inside a terminal.

18. The mobile terminal according to claim 17, wherein a format of the RFID tag data conforms to a code format based on one of EPC (Electronic Product Code) and ISO (International Standards Organization).

19. The mobile terminal according to claim 17, wherein the multi-tag decoder converts a code format based on one of EPC and ISO into a generalized form.
